(19) United States
(12) Patent Application Publication
(10) Pub. No.: US 2007/0063040 A1
(43) Pub. Date: Mar. 22, 2007

(54) Wireless tag scan device

(75) Inventor: Satoshi Ohishi, Mishima (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Toshiba Tec Kabushiki Kaisha, Shinagawa-ku (JP)

(21) Appl. No.: 11/386,875

(22) Filed: Mar. 22, 2006

(30) Foreign Application Priority Data
Sep. 21, 2005 (JP) 2005-274101

(51) Int. Cl. G06K 7/00; G06K 7/08

(52) U.S. Cl. 235/439; 235/440; 235/451

(57) ABSTRACT

As pairs of antennas driven under the same timing among antennas of respective groups, there are plural combinations whose selected two antennas have the distance therebetween set to be shortest.

### CROSS-REFERENCE TO RELATED APPLICATIONS

This application is based upon and claims the benefit of priority from the prior Japanese Patent Application No. 2005-274101, filed on 21 Sep. 2005; the entire contents of which are incorporated herein by reference.

### BACKGROUND OF THE INVENTION

1. Field of the Invention

The present invention relates to a wireless tag scan device, and more particularly, to a wireless tag scan device that can surely scan wireless tag information located at various positions.

2. Description of the Related Art

In a wireless tag system having a reader/writer antenna and an antenna, so as to reduce area in which communication cannot be performed, there is known a technique of shifting frequency phases of drive electric power to be sent to a plurality of antennas in a magnetic field type communication wireless tag system (e.g., Jpn. Pat. Appln. Laid-Open Publication No. 2004-199226).

The technique of above-described example is applied to the magnetic field type communication wireless tag system. In an electric wave type wireless tag system that scans a plurality of wireless tags with high speed, even if the communication range is large, there is raised directivity, and output electric waves from respective antennas interfere with each other. Therefore, the effect cannot be exerted. Furthermore, in the electric wave type wireless tag system, there is employed a method of arranging electric wave shields so as to prevent interference between a plurality of antennas, which undesirably increases the cost of a reader.

### BRIEF SUMMARY OF THE INVENTION

According to embodiments of the present invention, an object of the present invention is to provide a wireless tag scan device that can surely scan wireless tags of articles placed on a scan table.

The present invention may provide a wireless tag scan device that scans radio frequency ID of wireless tags which are attached to articles placed on a scan table, comprising: antennas of respective groups for communicating with the wireless tags, which face with each other; wherein, as pairs of antennas driven under the same timing among the antennas of respective groups, there are plural combinations whose selected two antennas have the distance therebetween set to be shortest.

### BRIEF DESCRIPTION OF THE DRAWINGS

FIG. 1 shows a schematic view indicative of the configuration of one embodiment of a wireless tag scan device according to the present invention; and

FIG. 2 shows a schematic view indicative of the configuration of another embodiment of a wireless tag scan device according to the present invention.

### DETAILED DESCRIPTION OF THE INVENTION

The wireless tag scan device according to the present invention will further be described below with reference to the accompanying drawings. In the drawings, similar parts or components are indicated with the same reference numerals, and detailed explanation of which will be omitted.

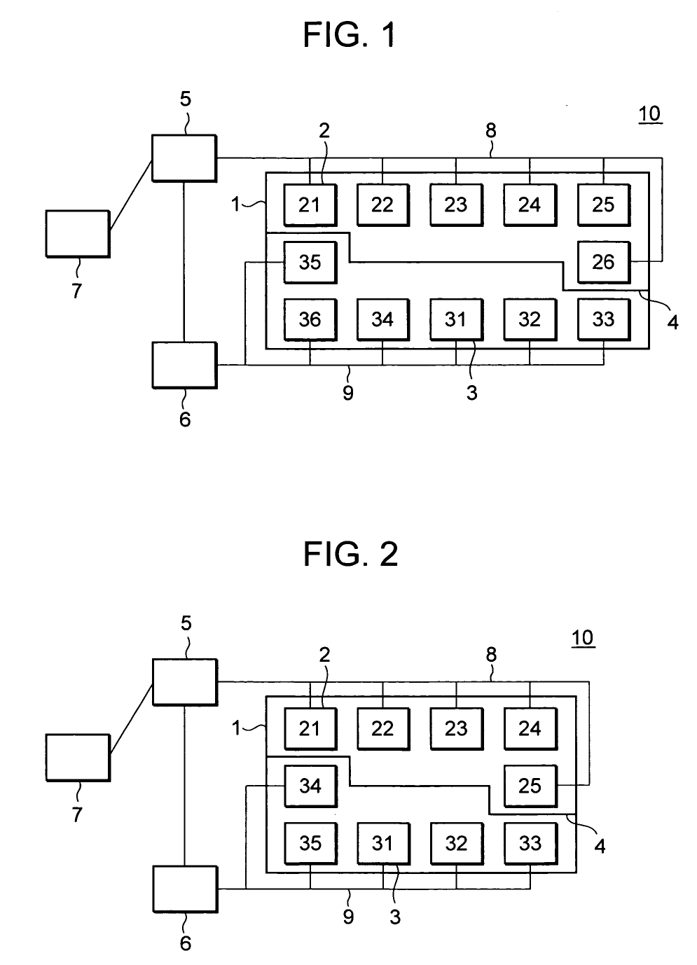

FIG. 1 shows a schematic view indicative of the configuration of a wireless tag scan device.

Wireless tags are attached to articles or deliveries, and are wireless data carriers, each of which is an independent component having a tag antenna that can transmit and receive an electric wave and an IC chip unitedly formed on a basal plate thereof. The IC chip includes a power generation unit for supplying respective parts of the IC chip with power by rectifying and stabilizing a modulated electric wave which is received by the tag antenna, a demodulation unit for demodulating a modulated electric wave to send thus demodulated data to a control unit, a modulation unit for modulating data sent from the control unit to send thus modulated data to the tag antenna, the control unit for writing data modulated by the modulation unit to a memory and for reading out transmission data from the memory to send thus readout data to the modulation unit, and the memory.

The memory has a radio frequency ID area that stores inherent radio frequency ID which is allocated and set up by a manufacturer when manufacturing wireless tags, and a user area to which the user can write arbitrary data. The user area has recorded therein an inherent pursuit management code of an article or a delivery to which the wireless tag is attached.

For example, mail articles and deliveries having attached thereto a wireless tag are carried by a belt conveyor. Then, thus carried mail articles and deliveries are brought out from the belt conveyor to be placed on a scan table of a wireless tag scan device for scanning wireless tags.

The wireless tag scan device has a transmission and reception antenna, and scans memory data of wireless tags located within the communication area of the transmission and reception antenna in a noncontact manner.

The wireless tag scan device is connected to a higher-level device such as a personal computer, and includes: an interface unit for receiving and sending data; a control unit having a CPU for controlling communication with wireless tags and a hardware connected thereto, a ROM having stored therein operation programs, a RAM for temporarily storing data, etc.; a modulation unit for modulating data sent from the control unit to generate a modulated signal suitable for radio communication; a transmission amplifier for amplifying a modulated signal to radiate thus amplified modulated signal from the transmission and reception antenna as an electric wave; a reception amplifier for amplifying an electric wave signal received by an antenna unit; and a demodulation unit for demodulating data of thus amplified electric wave signal to send thus demodulated data to the control unit.

When communicating with a wireless tag, a transmission unit modulates a carrier signal to transmit thus modulated carrier signal from a transmission antenna as a power electric wave signal, and then the transmission unit modulates data to be transmitted so that the data is overlapped on the power electric wave signal to transmit thus modulated data from the transmission antenna.

Mail articles and deliveries are placed on the scan table with their wireless tags directed upward or downward. Positions where the wireless tags are attached are different from one another. Furthermore, positions on the scan table where the mail articles and deliveries are placed are also different from one another.

As shown in FIG. 1, a wireless tag scan device 10 basically includes a wireless tag scan table 1 on which wireless tags are placed, a control unit 7 for communicating with the wireless tag scan device to process data within wireless tags, not shown, and carry out predetermined controls, a first scanner module 5 and a second scanner module 6 for scanning a large amount of wireless tags with high speed, and the first scanner module 5 are connected to six antennas 2 of the first group and the second scanner module 6 are connected to six antennas 3 of the second group through cables 8 and 9 respectively. In this embodiment, the six antennas 2 of the first group and the six antennas 3 of the second group are arranged substantially in the form of the letter “L”, and face with each other. It is desirable that the antennas are planar patch antennas that can radiate an electric wave over great distances.

Of the six antennas 2 of the first group, the first scanner module 5 drives one antenna as a transmission antenna, and drives another antenna as a reception antenna. The first scanner module 5 switches the transmission antenna and reception antenna in the order of 21, 22, 23, 24, 25, 26, 21, . . . , and communicates with wireless tags placed on the wireless tag scan table 1. The transmission antenna and the reception antenna may be the same antenna. Similarly, of the six antennas 3 of the second group, the second scanner module 6 drives one antenna as a transmission antenna, and drives another antenna as a reception antenna. The second scanner module 6 switches the transmission antenna and reception antenna in the order of 31, 32, 33, 34, 35, 36, 31, . . . , and communicates with wireless tags placed on the wireless tag scan table 1.

The first scanner module 5 controls switching antennas driven by itself, and controls the second scanner module 6 so that second scanner module 6 switches antennas in synchronization.

An electric wave shield 4 blocks an electric wave radiated from the antennas 2 of the first group and an electric wave radiated from the antennas 3 of the second group to prevent scan defect caused by interference. The electric wave shield 4 may be a member having attached thereto an aluminum foil, a copper foil, or the like which are provided with shield effect.

In the antenna arrangement shown in FIG. 1, the distance between antennas comes to be shortest when the antenna 21 and antenna 31, antenna 22 and antenna 32, antenna 23 and antenna 33, and antenna 24 and antenna 34 are driven concurrently, while the distance between antennas comes to be longest when the antenna 25 and antenna 35, antenna 26 and antenna 36 are driven concurrently, and the antenna mutual interference becomes large. In the embodiment, as pairs of antennas driven under the same timing among the antennas of respective groups, there are plural four combinations whose selected two antennas have the distance therebetween set to be shortest.

In the first embodiment shown in FIG. 1, the number of antennas in one group is six, to which the present invention is not restricted. In an example shown in FIG. 2, the number of antennas in one group is five. In the antenna arrangement shown in FIG. 2, the distance between antennas comes to be shortest when the antenna 21 and antenna 31, antenna 22 and antenna 32, antenna 23 and antenna 33 are driven concurrently, while the distance between antennas comes to be longest when the antenna 24 and antenna 34, antenna 25 and antenna 35 are driven concurrently, and the antenna mutual interference becomes large. In the embodiment shown in FIG. 2, as pairs of antennas driven under the same timing among the antennas of respective groups, there are plural three combinations whose selected two antennas have the distance therebetween set to be shortest.

In order to ensure scanning, the wireless tag scan table 1 is required to reduce loss of transmission energy from the transmission and reception antenna to the wireless tag.

That is, the wireless tag scan table 1 is made to work as a dielectric so that the transmission energy is not lost. Accordingly, material whose dielectric loss is small is desirable. For example, the wireless tag scan table 1 may be a plate made of Teflon or polycarbonate.

As described above, according to the embodiment, of pairs of antennas which are driven concurrently, a pair of antennas, which have the distance therebetween set to be shortest, have the distance made longer than that of conventional antennas, which can prevent interference between antennas. Accordingly, electric wave shields do not have to be arranged, or can be simplified, which can make it possible to surely scan wireless tags.

While the invention has been described hereinbefore, it should be understood that the invention is not limited to the embodiments, but various modifications, alternative constructions or equivalents can be implemented without departing from the scope and spirit of the present invention. Furthermore, various embodiments can be realized by arbitrarily combining the plural components disclosed in above-described embodiment. For example, some components may be omitted from all the components indicated in the embodiment, or components of other embodiments may be arbitrarily combined.

What is claimed is:

1. A wireless tag scan device that scans radio frequency ID of wireless tags which are attached to articles placed on a scan table, comprising:
antennas of respective groups for communicating with the wireless tags, which face with each other;
wherein, as pairs of antennas driven under the same timing among the antennas of respective groups, there are plural combinations whose selected two antennas have the distance therebetween set to be shortest.

2. The wireless tag scan device as set forth in claim 1, wherein the antennas of respective groups are arranged substantially in the form of the letter “L”, respectively.

3. The wireless tag scan device as set forth in claim 1, wherein the antennas of respective groups are six planar antennas, respectively.

4. The wireless tag scan device as set forth in claim 1, wherein the selected two antennas are a transmission antenna and a reception antenna.

5. The wireless tag scan device as set forth in claim 1, wherein an electric wave shield is arranged between the antennas of respective groups.

6. The wireless tag scan device as set forth in claim 5, wherein the electric wave shield includes an aluminum foil or a copper foil.
